(19) United States
(12) Patent Application Publication
(10) Pub. No.: US 2006/0265376 A1
(43) Pub. Date: Nov. 23, 2006

(54) Control method for server apparatus, control method for client apparatus, server apparatus, client apparatus, control program for server apparatus, control program for client apparatus and session control method

(75) Inventors: Junji Tagane, Fukuoka (JP); Ryoji Nakamatsu, Fukuoka (JP); Tomoyuki Furutono, Fukuoka (JP); Takashi Hidaka, Fukuoka (JP); Miwa Kususe, Fukuoka (JP)

Correspondence Address: BINGHAM MCCUTCHEN LLP, 3000 K STREET, NW, BOX IP, WASHINGTON, DC, 20007, US

(73) Assignee: Fujitsu Limited

(21) Appl. No.: 11/209,858

(22) Filed: Aug. 24, 2005

(30) Foreign Application Priority Data
May 19, 2005 (JP) 2005-147375

(51) Int. Cl. G06F 7/00

(52) U.S. Cl. 707/9

(57) ABSTRACT

The present invention provides a control method of a server apparatus intervening in a generation, maintenance and disconnection of a session which is set up for communication between a plurality of client apparatuses connecting with each other by way of an information network, comprising the processes of retaining, by the server apparatus, first session management information relating to a billing out of session management information which is created within the server apparatus at a generation of the session, and transmitting second management information other than the first management information to the client apparatus; and recovering the second session management information from the client apparatus to the server apparatus at a disconnection of the aforementioned session.

### BACKGROUND OF THE INVENTION

1. Field of the Invention

The present invention relates to a session control technique, and in particular to a technique effectively applicable to a server apparatus such as a softswitch which manages a session among a plurality of client apparatuses installed in an IP (Internet Protocol) network and to the aforementioned client apparatus, et cetera.

2. Description of the Related Art

A softswitch is known as a technique for replacing the function of relay telephone switch for example with an IP network and software processing therein. The softswitch, being installed as software in a server computer for example, carries out a connection control for a session connection between clients in an IP network. When carrying out such a session connection, a memory comprised by a softswitch retains billing management information and session setting information relating to the current session as a management-use data therefor.

The management-use data contained by the softswitch is continuously retained therewithin even in a stable session state during a session is in progress (simply “session in progress” hereinafter) so as to use for a salvation control for the session in progress when a failure of the softswitch necessitates an initialization for instance, thereby assuring the reliability of the softswitch.

A session control-use protocol for the IP network is a text base protocol with a good extendibility. But, just because it is a text base, much of the information retaining in a memory for use in a session setup is a character base and consequently a memory size required to retain in the memory becomes much larger than in the case of PSTN (public switched telephone network) telephone switch, hence possibly weighing on the heap area of the memory required for operating the soft switch and resulting in a degraded performance. Consequently, a development of new service involving the softswitch is faced with a technical problem of memory usage volume becoming a bottle neck, that is, the memory usage volume for storing management-use data which is further enlarged by an addition of management information for the aforementioned new service. Meanwhile, because the above noted management-use data is retained by the memory continuously during a session in progress, the number of simultaneously communicable sessions is limited (i.e., determined) by a memory capacity of server apparatus installing a softswitch. More numbers of simultaneously connected sessions should be able to be controlled originally. However, there is a problem that it cannot help limiting the numbers of sessions according to the amount of the memory under the present situation.

Another technical problem is that, while a failure of the softswitch during a session in progress is assured for the reliability by a recovery processing for the communicating session through an initialization by using the above noted management-use data, its increase in association with the number of simultaneously communicating sessions makes an access time to the management-use data that much longer, hence elongating the time required for a recovery processing by an initialization of the session.

When collecting a session control signal during session in progress as log information, it is conceivable to enable a maintenance manager to reference by accumulating the log information in the memory within a softswitch. In this case the memory capacity in the softswitch is finite and therefore an unlimited collection of the log information is impossible. Because of this, the choice is to collect only the latest log information by overwriting log information in the memory area, but the concern is that there may be an incidence where the log information about a discretionary client is already overwritten when a reference thereto is necessary, hence making it difficult to use the log information.

It is also conceivable to collect log information only about a specific client selectively by specifying the specific client beforehand by a maintenance command and registering a start timing for collecting the log information, but a technical problem in this case is that such log information is not available prior to the aforementioned registration.

As described so far, retaining the management-use data and log information used for carrying out a session control by the softswitch in the memory there within during a session in progress has brought about a various technical problems as described above.

In the meantime, the patent document 1 has disclosed a technique in which packet switching equipment retains a call setup data stored by a call control memory at an initial call request and carries out a call setup by using the call setup data stored in the call control memory when repeating the call request. The case of patent document 1, however, did not disclose a reduction of management data and log information such as call setup data retained in the packet switching equipment.

[Patent document 1] Japanese patent laid-open application publication No. 06-343078

### SUMMARY OF THE INVENTION

A purpose of the present invention is to increase the number of simultaneously manageable sessions with no degradation of session management performance caused by a memory shortage for a softswitch with a finite capacity of memory storing session management information necessary for managing each session.

Another purpose of the present invention is to enable the additions of various services with no degradation of session management performance caused by a memory shortage within a softswitch with a finite capacity of memory storing session management information necessary for managing each session.

A further purpose of the present invention is to make it possible to collect log information about each session with no degradation of session management performance caused by a memory shortage for a softswitch with a finite capacity of memory storing session management information necessary for managing each session.

Yet another purpose of the present invention is to enable a collection of log information about each session with a high degree of freedom for a softswitch with a finite capacity of memory storing session management information necessary for managing each session.

A first aspect of the present invention is to provide a control method of a server apparatus intervening in a generation, maintenance and disconnection of session which is set up for communication between a plurality of client apparatuses connecting with each other by way of an information network, comprising the processes of retaining, by the server apparatus, first session management information relating to a billing out of session management information which is created within the server apparatus at a generation of the session, and transmitting second management information other than the first management information to the client apparatus; and recovering the second session management information from the client apparatus to the server apparatus at a disconnection of the aforementioned session.

A second aspect of the present invention is to provide a control method of a client apparatus carrying out communication with another client apparatus by way of a session controlled for its generation, maintenance and disconnection by an intervention of server apparatus, comprising the processes of configuring session management information created within the server apparatus at a generation of the session, and retaining second management information, received from the server apparatus, out of first session management information relating to a billing and the second session management information other than the first session management information; and transmitting the second session management information to the server apparatus at a disconnection of the session.

A third aspect of the present invention is to provide a server apparatus for intervening in a generation, maintenance and disconnection of session which is set up for communication between a plurality of client apparatuses connecting with each other by way of an information network, comprising control logics for the operations of retaining a first session management information relating to a billing, and transmitting second session management information other than the first session management information to the client apparatus, out of session management information created within the server apparatus in order to manage a session at the generation of the aforementioned session; and recovering the second session management in formation from the client apparatus at a disconnection of the aforementioned session.

A fourth aspect of the present invention is to provide a client apparatus for carrying out communication with another client apparatus by way of a session controlled for its generation, maintenance and disconnection by an intervention of server apparatus, comprising control logics for the operations of configuring session management information created within the server apparatus at a generation of the session in order to manage the aforementioned session, and retaining second management information, received from the server apparatus, out of first session management information relating to a billing and the second session management information other than the first session management information; and transmitting the second session management information to the server apparatus at a disconnection of the session.

A fifth aspect of the present invention is to provide a signal for carrying a control program of a server apparatus intervening in a generation, maintenance and disconnection of session which is set up for communication between a plurality of client apparatuses connecting with each other by way of an information network, wherein the program makes the server apparatus carry out the processes of the server apparatus retaining a first session management information relating to a billing, and letting the client apparatus retain second session management information other than the first session management information, out of session management information created within the server apparatus in order to manage a session at the generation of the aforementioned session; and recovering the second session management information from the client apparatus to the server apparatus at a disconnection of the aforementioned session.

A sixth aspect of the present invention is to provide a signal for carrying a control program of a client apparatus for carrying out communication with another client apparatus by way of a session controlled for its generation, maintenance and disconnection by an intervention of server apparatus, wherein the program makes the client apparatus carry out the processes of configuring session management information created within the server apparatus at a generation of the session in order to manage the aforementioned session, and retaining second management information, received from the server apparatus, out of first session management information relating to a billing and the second session management information other than the first session management information; and transmitting the second session management information to the server apparatus at a disconnection of the session.

A seventh aspect of the present invention is to provide a session control method of information communication system including a plurality of first information processing apparatuses which are connected by way of an information network, and a second information processing apparatus, being connected with the information network, for intervening in a generation, maintenance and disconnection of session which is set up for communication between a plurality of the first information processing apparatus, comprising the processes of the second information processing apparatus retaining a first session management information relating to a billing, and letting the first information processing apparatus retain second session management information other than the first session management information, out of session management information created within the second information processing apparatus in order to manage a session at the generation of the aforementioned session; and recovering the second session management information from the first information processing apparatus to the second information processing apparatus at a disconnection of the aforementioned session.

The present invention comprises itself, when a session which has been generated between two client apparatuses as a result of intervention by a softswitch installed in a server apparatus transits to a session in communication, for the server to retain first session management information for instance relating to a billing which requires a security, move a second session management information, other than the aforementioned first session management information from under the management of the softswitch to that of the client apparatus, out of session management information created within the softswitch in order to manage the aforementioned session, and manage it by using a memory comprised by the client apparatus or an external storage apparatus.

And managing the first session management information in need of security only by the memory comprised by the softswitch during the communication and recovering the second session management information being managed over at the client apparatus back to the softswitch at the disconnection of the session restore the session management information for setting up the session within the softswitch so as to operate the session disconnection processing normally.

This merely requires the softswitch to secure the memory areas for billing information in need of security and for a session management information-use to accommodate the number of simultaneous sessions which can occur within a setup processing time for one session, thereby enabling a reduction of memory capacity in order to manage a session by the softswitch.

As a result, it is possible to increase the number of simultaneously manageable sessions without causing degradation in a session management performance due to a shortage of memory capacity in a softswitch with a finite memory capacity.

Meanwhile, a development of additional service to be supported by the softswitch increases an information volume of the above described second session management information, but an information volume to be retained on the part of the softswitch during each session being maintained will not actually increase because the second session management information is retained over at each client apparatus engaging in the respective session. It is therefore possible to add a diverse service to the softswitch with no concern over a shortage of memory capacity on the part thereof.

Furthermore, each of a plurality of client apparatuses, which uses a session generated by the above described softswitch, collects continuously and accumulates log information on session control-use signals on the part of the client. This enables a recovery of the log information from the client apparatus over to the softswitch through a maintenance procedure without requiring the softswitch for instance to register a log collection by specifying a specific client in advance.

### BRIEF DESCRIPTION OF THE DRAWINGS

FIG. 1 is a conceptual diagram exemplifying a comprisal of information network carrying out a session control method as an embodiment of the present invention;

FIG. 2 is a conceptual diagram exemplifying a software comprisal of softswitch and a plurality of clients constituting an information network as an embodiment of the present invention;

FIG. 3A is a conceptual diagram exemplifying an internal comprisal of software constituting a softswitch in more detail;

FIG. 3B is a conceptual diagram exemplifying an internal comprisal of software constituting a softswitch in more detail;

FIG. 4A is a conceptual diagram exemplifying an internal comprisal of software constituting a client apparatus in more detail;

FIG. 4B is a conceptual diagram exemplifying an internal comprisal of software constituting a client apparatus in more detail;

FIG. 5 is a block diagram exemplifying a hardware comprisal of SIP server functioning as softswitch as an embodiment of the present invention;

FIG. 6 is a block diagram exemplifying a hardware comprisal of client apparatus as an embodiment of the present invention;

FIG. 7 is a conceptual diagram exemplifying a comprisal of information network as an embodiment of the present invention in further detail;

FIG. 8 is a sequence chart exemplifying a message sequence from a call request to an establishment of call;

FIG. 9 describes an example of INVITE message;

FIG. 10 describes an example of 200 OK message being set up with a session setting data;

FIG. 11 describes an example of ACK message being set up with a session setting data;

FIG. 12 is a sequence chart exemplifying a message sequence for an SIP session from a call in progress to the disconnection;

FIG. 13 describes an example of BYE message being set up with a session setting data;

FIG. 14 is a sequence chart exemplifying a processing at an occurrence of terminal failure during a call;

FIG. 15 is a sequence chart exemplifying a processing at an occurrence of failure in an SIP server during a call in progress;

FIG. 16 is a sequence chart showing a message sequence when connecting a plurality of sessions simultaneously;

FIG. 17 is a sequence chart showing a collection processing for session logs in a modified embodiment of the present invention;

FIG. 18 describes an example of INFO message being set up with a log collection request message; and

FIG. 19 describes an example of 200 OK message being set up with log information.

### DESCRIPTION OF THE PREFERRED EMBODIMENTS

The following is a detailed description of the preferred embodiment of the present invention while referring to the accompanying drawings.

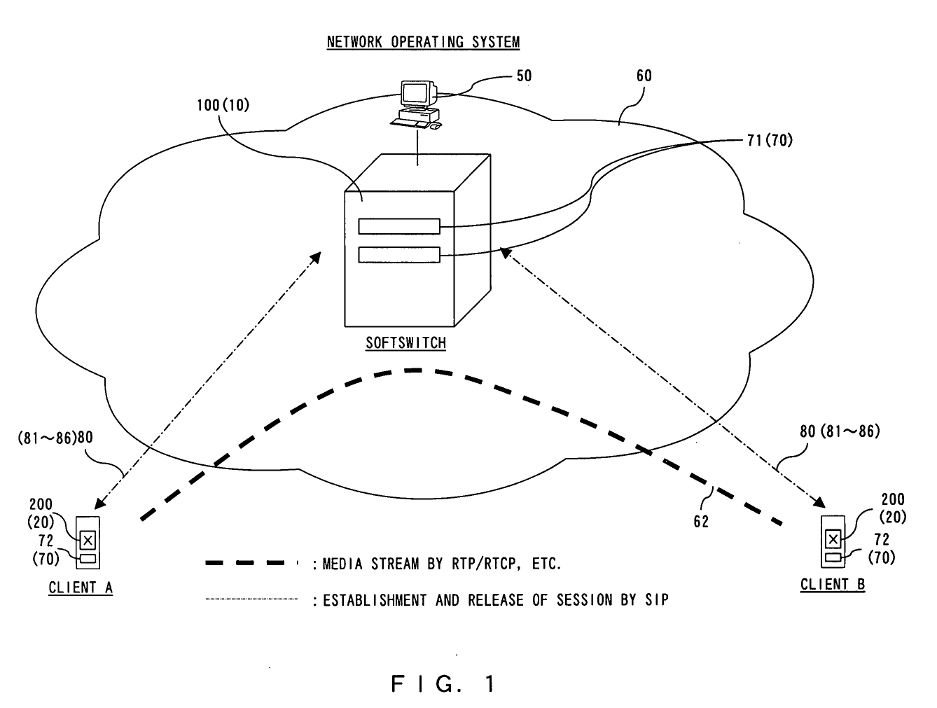

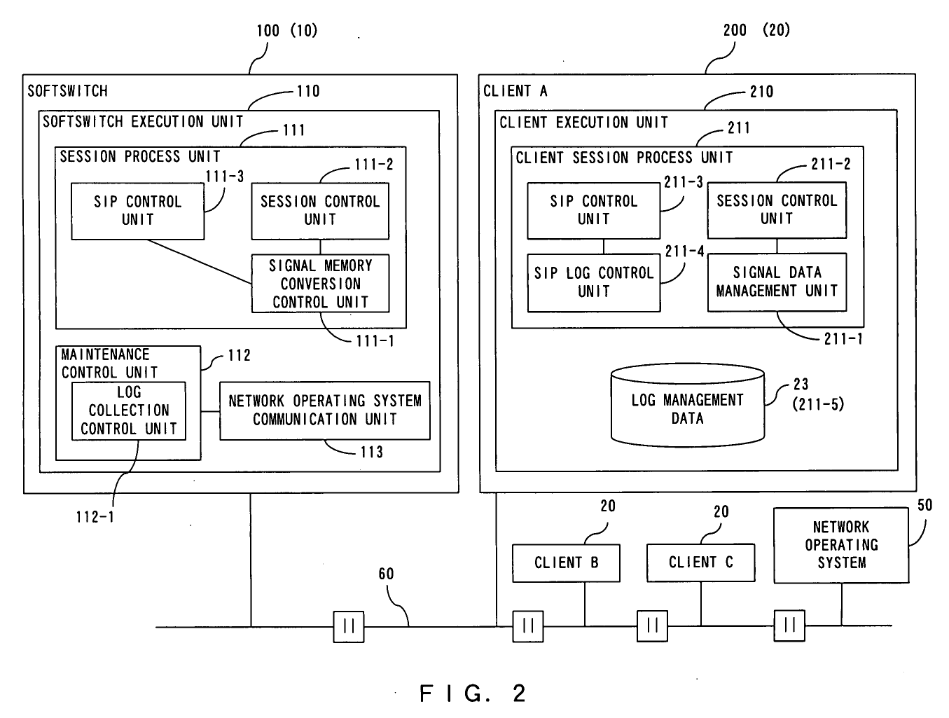

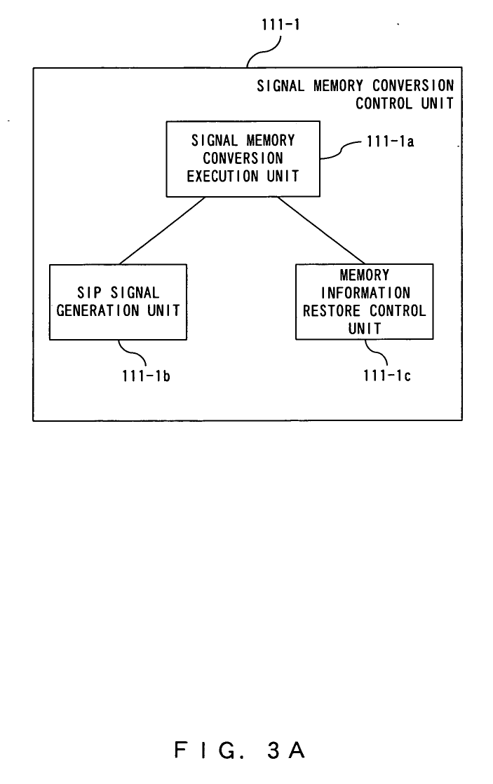

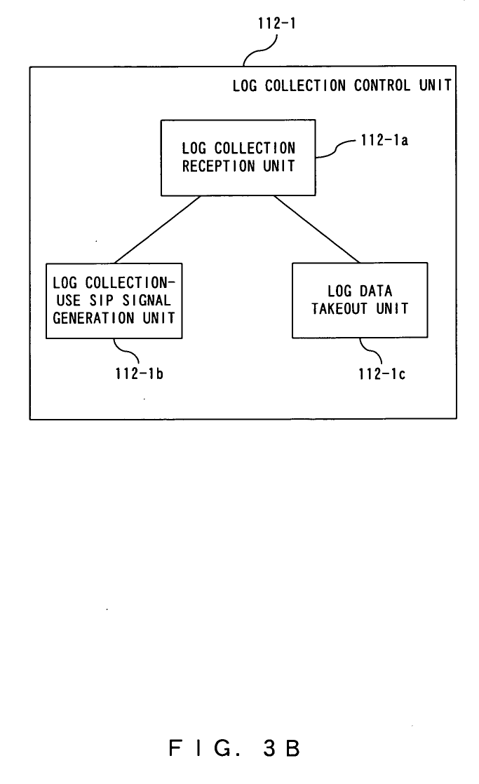

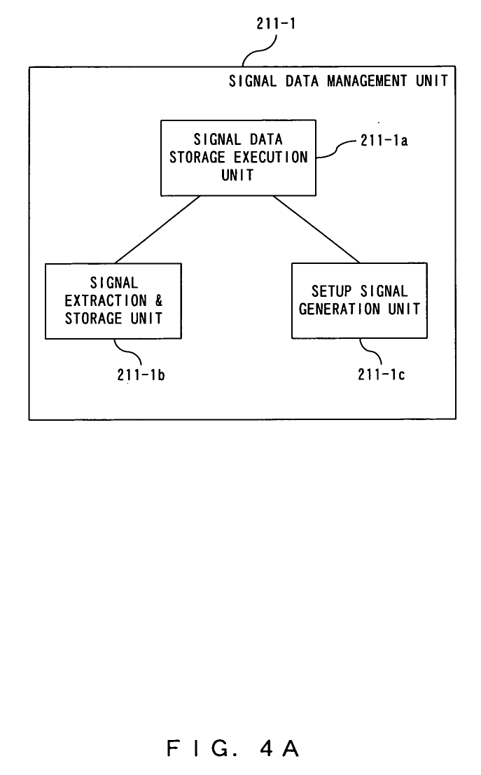

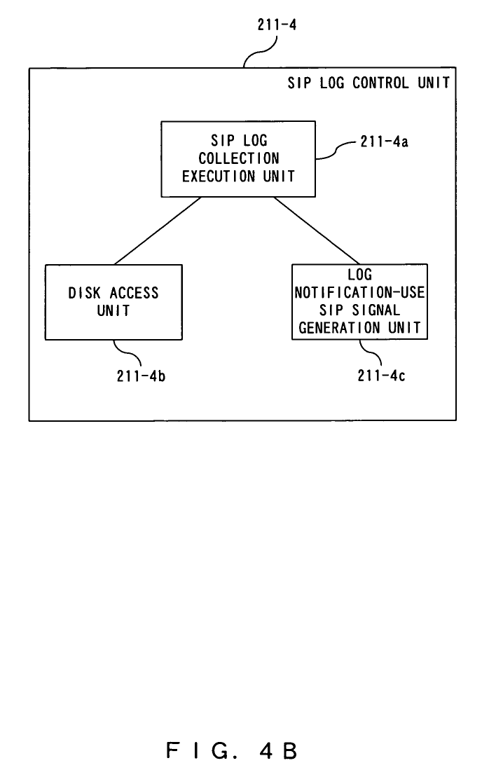

FIG. 1 is a conceptual diagram exemplifying a comprisal of information network carrying out a session control method as an embodiment of the present invention; FIG. 2 is a conceptual diagram exemplifying a software comprisal of softswitch and plurality of clients constituting an information network according to the present embodiment; FIG. 3A and 3B each is a conceptual diagram exemplifying an internal comprisal of software constituting a softswitch in more detail; and FIG. 4A and 4B are each a conceptual diagram exemplifying an internal comprisal of software constituting a client apparatus in more detail.

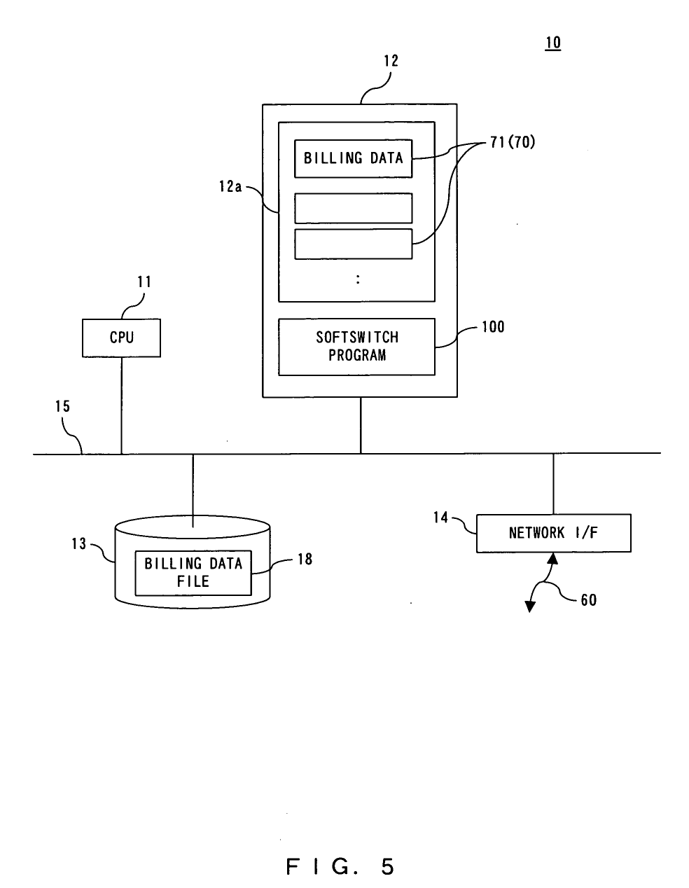

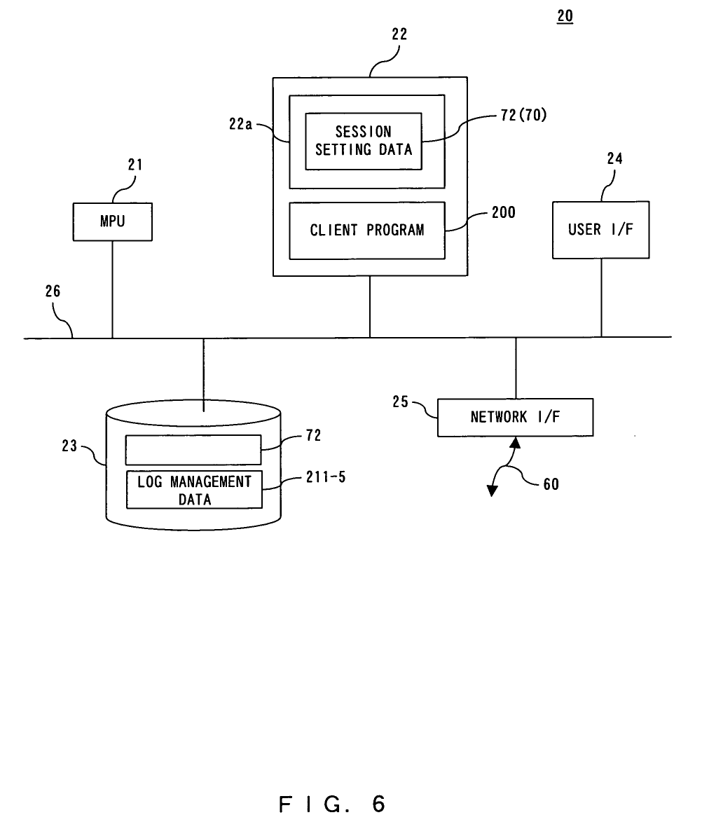

Then, FIG. 5 is a block diagram exemplifying a hardware comprisal of SIP server functioning as softswitch according to the present embodiment; and FIG. 6 is a block diagram exemplifying a hardware comprisal of client apparatus according to the present embodiment.

As exemplified by FIG. 1, the present embodiment is comprised to interconnect an SIP server 10 (i.e., second information processing apparatus) functioning as softswitch and a plurality of clients 20 (i.e., first information processing apparatuses) by way of a network 60, and further interconnecting a network operating system 50.

As exemplified by FIG. 5, the SIP server 10 functions as softswitch by installing itself with a softswitch program 100. The SIP server 10 according to the present embodiment comprises for example a CPU 11, a main storage 12, an external storage apparatus 13, a network interface 14 and a bus 15.

The CPU (central processing unit) 11 controls an entirety of the SIP server 10 by executing a program stored by the main storage 12. The present embodiment is configured to install a softswitch program 100 in the main storage 12 so that the SIP server 10 functions as softswitch for controlling a session between a plurality of clients 20 by using an SIP (i.e., session initiation protocol) by executing the softswitch program 100.

The main storage 12 provides itself with a memory area 12a for storing data such as session management information 70 created by the softswitch program 100. The session management information 70 includes a billing data 71 (i.e., first session management information) and a session setting data 72 (i.e., second session management information) other than the aforementioned billing data 71.

The external storage apparatus 13 stores the softswitch program 100 which will be loaded onto the main storage 12. The external storage apparatus 13 also equips itself with a billing data file 18 which will be recorded by the billing data 71 within the session management information 70 in the memory area 12a on an as required basis.

As described later, the present embodiment is comprised to let the SIP server 10 store the important information such as the billing data 71 which relates to billing processing for a session out of the session management information 70 created in the memory area 12a for each session, and to let the plurality of clients 20 engaging in the aforementioned session store the session setting data 72 other than the billing data 71 by embedding in a SIP signal 80 and sending thereto, thereby releasing the storage area for the session setting data 72 within the memory area 12a. This reduces an area of the memory area 12a required for retaining a session setting data 72 for the SIP server 10.

Then the processing at a disconnection of the session (i.e., end) is to recover the session setting data 72 from the client 20 over to the SIP server 10.

The network interface 14 connects the SIP server 10 with the network 60 by a prescribed protocol.

The bus 15 is an information transmission path interconnecting the above described components constituting the SIP server 10.

The client 20 is comprised by a discretionary information processing apparatus such as a PC (personal computer), stationary telephone, mobile phone, PDA, et cetera.

As exemplified by FIG. 6, the client 20 according to the present embodiment comprises for example an MPU (micro processor unit) 21, a main storage 22, a hard disk 23, a user interface 24, a network interface 25 and a bus 26.

The MPU 21 controls an entirety of the client 20 by executing a program stored in the main storage 22. The present embodiment is configured so that the main storage 22 stores a client program 200. And the MPU 21 executing the client program 200 accomplishes information communication with another client 20 by using a session by the SIP under the control of the SIP server 10.

And a memory area 22a of the main storage 22 stores a part of the session management information 70 (i.e., session setting data 72 in this case) received at the time of later described session control between the SIP server 10.

The hard disk 23 stores a session setting data 72 saved from the memory area 22a, and a log management data 211-5 (i.e., log information) recording, in a time series, an SIP signal 80 which has been exchanged with the SIP server 10 or the client 20 during a session.

The user interface 24 is comprised by a display, camera, microphone, speaker, key board, for example. And if the client 20 is an IP telephone, a microphone and a speaker constitute a handset; and if an IP video phone, photographing and displaying a screen image can use a display and a camera.

The network interface 25 connects a client 20 with the network 60 by a prescribed protocol.

The bus 26 is an information transmission path interconnecting the above described components for the client 20.

As exemplified by FIG. 2, the softswitch program 100 comprises a softswitch execution unit 110 which includes a session process unit 111, a maintenance control unit 112 and a network operating system communication unit 113.

The session process unit 111 includes a signal memory conversion control unit 111-1, a session control unit 111-2 and an SIP control unit 111-3. The maintenance control unit 112 includes a log collection control unit 112-1.

Meanwhile, the client program 200 comprises a client execution unit 210 which includes a client session process unit 211.

The client session process unit 211 includes a signal data management unit 211-1, a session control unit 211-2, an SIP control unit 211-3 and an SIP log control unit 211-4.

As shown by FIG. 3A, the signal memory conversion control unit 111-1 comprised by the softswitch program 100 includes a signal memory conversion execution unit 111-1a, an SIP signal generation unit 111-1b and a memory information restore control unit 111-1c.

As shown by FIG. 3B, the log collection control unit 112-1 comprised by the softswitch program 100 includes a log collection reception unit 112-1a, a log collection-use SIP signal generation unit 112-1b and a log data takeout unit 112-1c.

As shown by FIG. 4A, the signal data management unit 211-1 includes a signal data storage execution unit 211-1a, signal extraction & storage unit 211-1b, and a setup signal generation unit 211-1c.

As shown by FIG. 4B, the SIP log control unit 211-4 includes an SIP log collection execution unit 211-4a, a disk access unit 211-4b and a log notification-use SIP signal generation unit 211-4c.

The function of each unit comprised by the softswitch program 100 and client program 200, respectively, is exemplified as listed below:

(1) The softswitch program 100 interprets an SIP protocol at the softswitch execution unit 110, and establishes and releases an SIP session with a plurality of clients 20.

(2) The softswitch execution unit 110 interprets an SIP protocol at the session process unit 111, and establishes and releases an SIP session with a plurality of clients 20.

(3) The session process unit 111 provides a session control function based on the SIP protocol.

(4) The signal memory conversion control unit 111-1 sets up, in an SIP signal 80 (e.g., later described 200 OK message 82, ACK message 83, et cetera), a session setting data 72 within the session management information 70 stored by the memory area 12a, based on instructions from the session control unit 111-2 and SIP control unit 111-3. Also, it carries out a restore control for a session setting data 72 in an incoming SIP signal 80 (i.e., a later described BYE message 84) from a client 20 to the memory area 12a.

(5) Having received a request from the session control unit 111-2 or the SIP control unit 111-3, for setting a session setting data 72 stored by the memory area 12a in an SIP signal 80, the signal memory conversion execution unit 111-1a starts up the SIP signal generation unit 111-1b, sets up the session setting data 72 in the SIP signal 80 and returns the SIP signal 80 to the session control unit 111-2 or the SIP control unit 111-3. When receiving a memory information restore request from the session control unit 111-2 or the SIP control-unit 111-3, the signal memory conversion execution unit 111-1a requests the memory information restore control unit 111-1c for extracting the information (i.e., session setting data 72) for restoring from the SIP signal 80 to the session management information 70 in the memory area 12a and returns the extracted restore information (i.e., session setting data 72) back to the session control unit 111-2 or the SIP control unit 111-3.

(6) Having received a request for setting the session setting data 72 stored by the memory area 12a in an SIP signal 80, the SIP signal generation unit 111-1b sets the session setting data 72 in the message body part of the SIP signal 80 and returns the SIP signal 80 with the session setting data 72 being set therein.

(7) Having received a request for restoring the session setting data 72 contained by the SIP signal 80 to the session management information 70 in the memory area 12a, the memory information restore control unit 111-1c extracts and returns the session setting data 72 to be restored from the message body part of the SIP signal to the session management information 70 in the memory area 12a.

(8) The session control unit 111-2 uses the SIP signal 80 received from the SIP control unit 111-3 to carry out a session setup processing between clients 20; and, if the setup processing is followed by transiting to a session in progress, sets a session setting data 72, which is the information other than a billing data 71 out of session management information 70 retained by the memory area 12a during a session in communication, in an SIP signal 80 by requesting the signal memory conversion control unit 111-1 therefor to carry out a release processing for the memory area 12a which has been used by the aforementioned session setting data 72.

(9) The SIP control unit 111-3 performs decode & encode processing for the SIP signal 80 to carry out a session control in collaboration with the session control unit 111-2. The SIP control unit 111-3 manages by itself each transaction as per the SIP protocol. After transmiting to a session in communication, the SIP control unit 111-3 requests the signal memory conversion control unit 111-1 for setting a session setting data 72, which is retained by the memory area 12a during a session in communication, in an SIP signal 80 to carry out a release processing for the area for storing the session setting data 72 in the memory area 12a.

(10) The maintenance control unit 112 carries out a maintenance control when receiving a request from the network operating system communication unit 113 for a maintenance related processing; and request the log collection control unit 112-1 for a log collection when receiving a request for collecting logs on the SIP signals 80.

(11) Having received a request for collecting logs on the SIP signals 80 from the maintenance control unit 112, the log collection control unit 112-1 creates a log collection-use SIP signal (i.e., a later described INFO message 85) and requests the SIP control unit 111-3 for transmitting the aforementioned log collection-use SIP signal to a client 20.

(12) Having received the request for collecting logs on the SIP signals 80, the log collection reception unit 112-1a requests the log collection-use SIP signal generation unit 112-1b for generating a log collection-use SIP signal, followed by requesting the SIP control unit 111-3 for transmitting the aforementioned generated log collection-use SIP signal to the client 20. The log collection reception unit 112-1a requests the log data takeout unit 112-1c for a SIP signal response received from the client 20. The log collection reception unit 112-1a extracts [p1]the log data out of the log data takeout unit 112-1c, and responds back to the network operating system 50 with the log data.

(13) Having received a request for generating a log collection-use SIP signal for use in collecting logs on the SIP signals 80, the log collection-use SIP signal generation unit 112-1b generates an SIP request signal.

(14) The log data takeout unit 112-1c extracts a log data out of the message-body part of the received SIP response signal (i.e., a later described 200 OK message).

(15) The network operating system communication unit 113 receives an order from the network operating system 50 which is connected by way of the network 60; and transfers the order to the maintenance control unit 112, and requests for obtaining a log data about SIP signals 80.

(16) The client program 200 over at the client 20 lets the client execution unit 210 interpret an SIP protocol to carry out an establishment and/or release of SIP session.

(17) The client execution unit 210 lets the client session process unit 211 interpret an SIP protocol to carry out an establishment and/or release of SIP session.

(18) The client session process unit 211 provides the function of session control based on the SIP protocol.

(19) In compliance with a request from the session control unit 211-2, the signal data management unit 211-1 stores a session setting data 72, which has arrived from the SIP server 10 riding on an SIP signal 80, in either the memory area 22a or the hard disk 23; and also conversely sets a session setting data 72 stored by the memory area 22a or hard disk 23 in an SIP signal 80.

(20) Having received a request for extracting a session setting data 72 out of the incoming SIP signal 80 from the SIP server 10 and for writing in the memory area 22a or hard disk 23, the signal data storage execution unit 211-1a requests a later described signal extraction & storage unit 211-1b for extracting a session setting data 72 out of the SIP signal 80; and also conversely requests the setup signal generation unit 211-1c for setting a session setting data 72 stored by the memory area 22a or hard disk 23 in an SIP signal 80.

(21) The signal extraction & storage unit 211-1b extracts a session setting data 72 which is set in the message body part of the incoming SIP signal 80 from the SIP server 10 to store in either the memory area 22a or the hard disk 23.

(22) The setup signal generation unit 211-1c sets a setting a session setting data 72 stored by the memory area 22a or hard disk 23 in the message-body part of an SIP signal 80 which will be transmitted out to the SIP server 10.

(23) The session control unit 211-2 carries out a session setup processing by using an SIP signal 80 received from the SIP control unit 211-3; and, if the setup processing is followed by a call in progress, have the session setting data 72 stored in either the memory area 22a or the hard disk 23 by requesting the signal data management unit 211-1, since the session setting data 72 which has been set by the SIP server 10 (i.e., the softswitch) exists in the SIP signal 80.

(24) The SIP control unit 211-3 performs decode & encode controls for an SIP signal 80 and carries out a session control in collaboration with the session control unit 211-2. The SIP control unit 211-3 by itself manages each transaction by the SIP protocol. The SIP control unit 211-3 requests the SIP log control unit 211-4 with regard to the transmission & receiving signal of each SIP transaction and collects a log data on the SIP signals 80 in either the memory area 22a or the hard disk 23. Meanwhile, if an SIP signal 80 requesting for collecting a log data is received from the softswitch program 100 (i.e., SIP server 10), the SIP control unit 211-3 requests the SIP log control unit 211-4 for setting the log data in an SIP response for a log data response-use and transmits the aforementioned SIP response (i.e., a later described 200 OK message 86) back to the SIP server 10.

(25) Having received a request for logging an SIP signal 80 from the SIP control unit 211-3, the SIP log control unit 211-4 starts up the SIP log collection execution unit 211-4a to store the log data on the SIP signal 80 in either the memory area 22a or the hard disk 23; and also, having received an SIP signal 80 from the softswitch (i.e., SIP server 10) for collecting an SIP log, returns the logging data back by setting in an SIP response.

(26) Having received a request for logging an SIP signal 80, the SIP log collection execution unit 211-4a requests the disk access unit 211-4b for collecting log information in either the memory area 22a or the hard disk 23; and also, having received an SIP signal 80 for collecting an SIP log, extracts log information out of the disk access unit 211-4b to request the log notification-use SIP signal generation unit 211-4c for generating an SIP response.

(27) Having received a request for storing an SIP signal 80, the disk access unit 211-4b stores the SIP signal 80 in either the memory area 22a or the hard disk 23; and, also reads an SIP signal 80 out of either the memory area 22a or the hard disk 23 when receiving a request for reading as such.

(28) Having received a request for setting the SIP signal log in an SIP response, the log notification-use SIP signal generation unit 211-4c generates the SIP response signal.

(29) The individual clients 20 establish a call byway of the softswitch (i.e., SIP server 10) to carry out a mutual communication.

(30) The network operating system 50 controls the elements (e.g., softswitch, and routers 61) on the network 60 remotely.

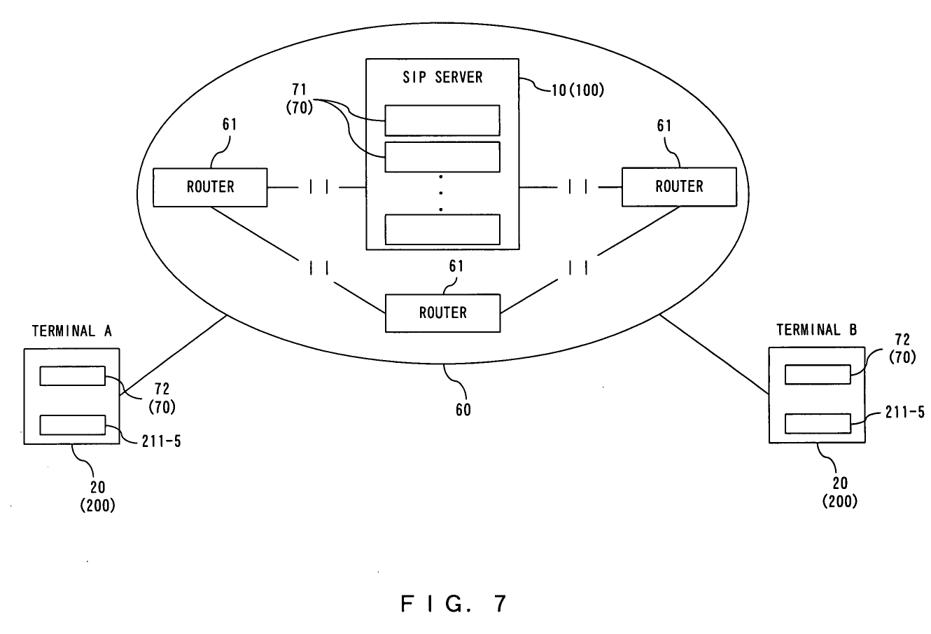

FIG. 7 is a conceptual diagram exemplifying a comprisal of information network according to the present embodiment in further detail.

A plurality of path control apparatuses such as routers 61 exist in a network 60 comprising an IP (Internet Protocol) network for instance, and an SIP server 10 being installed by a softswitch program 100 so as to function as softswitch is connected with a plurality of clients 20 by way of the network 60 and the routers 61. Each client is an IP terminal capable of IP communication.

That is, the present embodiment is comprised so that the SIP server 10 with the function of softswitch carries out a communication between clients 20 in which the SIP protocol is used for calling & receiving.

The following description is about an example operation of the present embodiment.

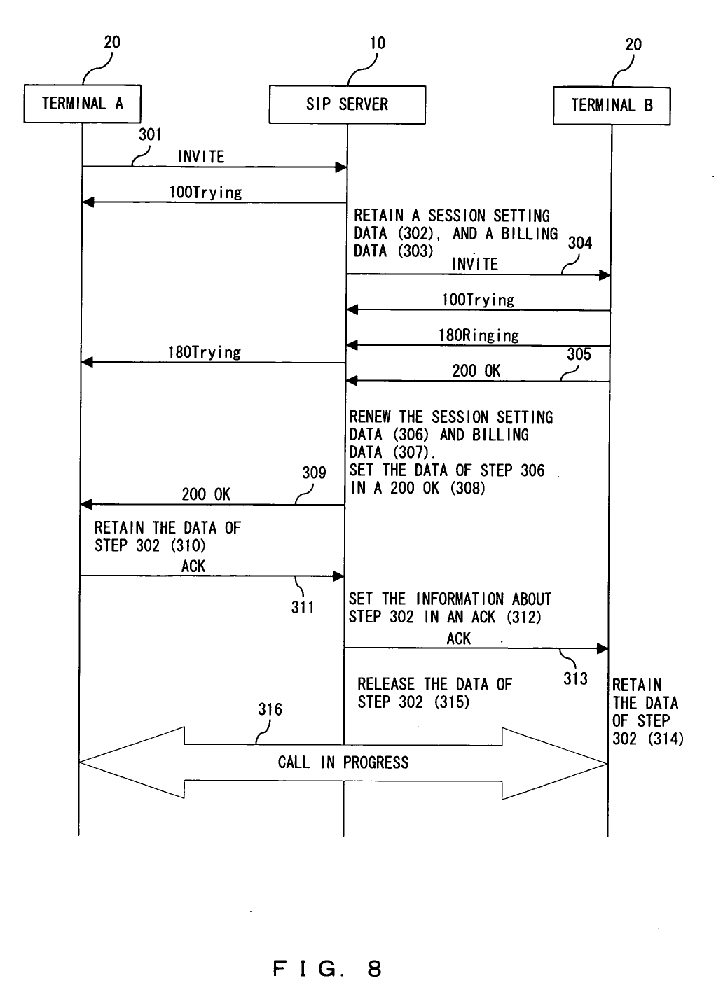

FIG. 8 is a sequence chart exemplifying a message sequence from a call request to an establishment of call between a plurality of clients 20 (i.e., terminals A and B) and the SIP server 10.

Having received an INVITE message transmitted from a calling terminal A, the SIP server 10 (step 301) retains data, in the memory area 12a, such as session management information 70 which must be retained in order to carry out a session setup operation. The data other than a billing data 71 out of the session management information 70 is called a session setting data 72 (step 302).

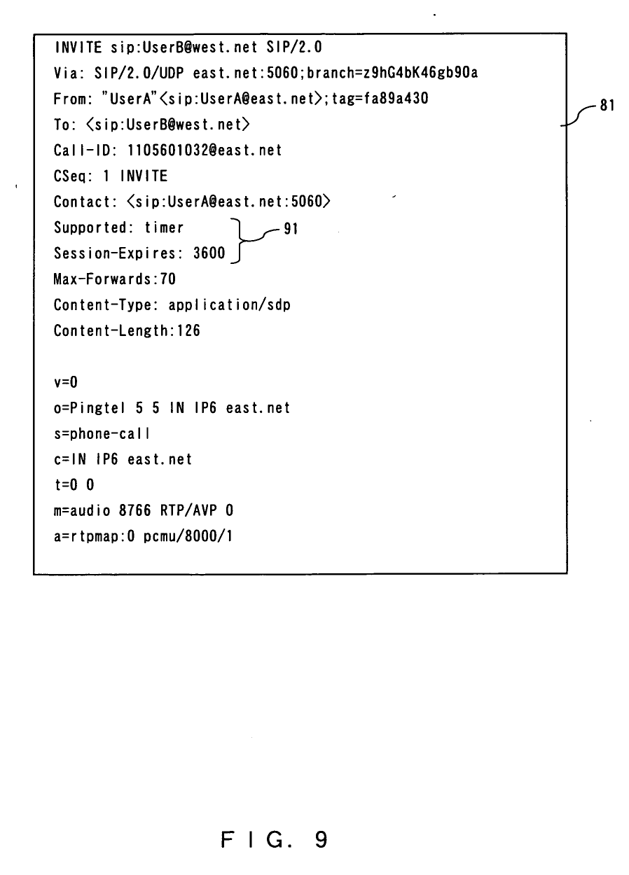

FIG. 9 shows an example of INVITE message 81 sent out of the caller terminal A in the above described event. The SIP server 10 receives an INVITE message 81 shown by FIG. 9 and retains necessary information within the aforementioned message as a session setting data 72 in the memory area 12a as a part of the session management information 70. Then the SIP server 10 retains, as billing information, a session start clock time and call-receive information (e.g., call-ID) in the memory area 12a as a billing data 71 constituting a part of the session management information 70 (step 303) and transmits an INVITE message to a receiver terminal B (step 304).

Having received a 200 OK message from the receiver terminal B, the SIP server 10 (step 305) stores the information such as positional information about the receiver terminal out of the 200 OK message in a part of the session management information 70 (step 306) and collects a call start clock time, et cetera, for the billing data 71 (step 307).

The SIP server 10 sets the session setting data 72 as well as an SDP (session description protocol) in the message body part of the 200 OK message 82 which has been received over from the receiver terminal B (step 308).

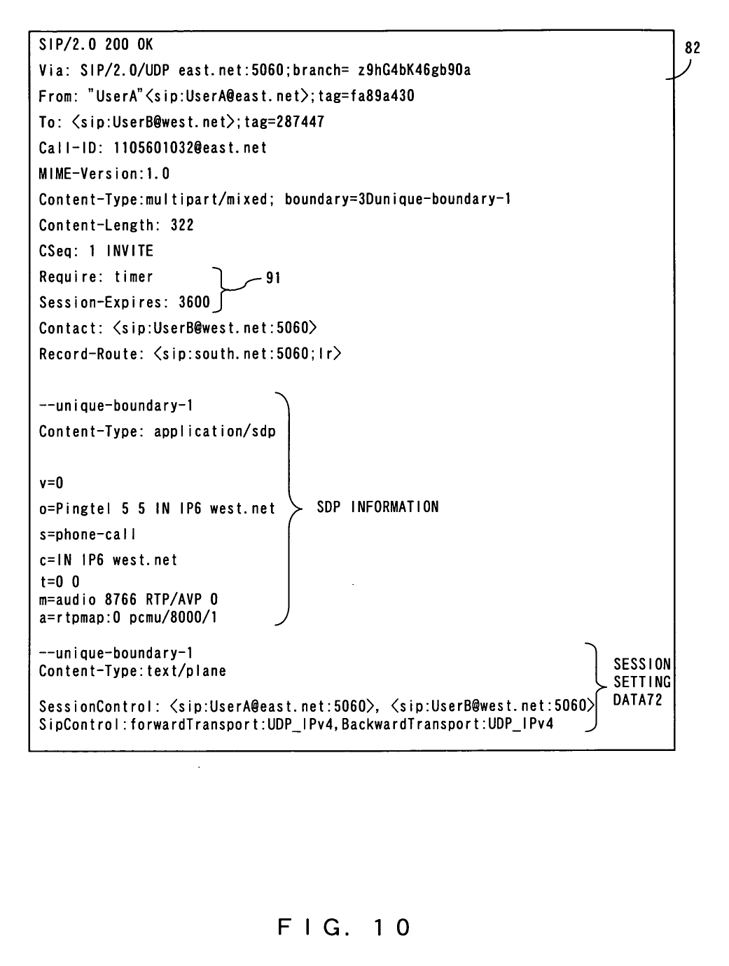

FIG. 10 shows an example of 200 OK message 82 which is set up with a session setting data 72. Describing a 200 OK massage 82 in detail, a message-body part of SDP followed by a Content-type setting up the message-body part of text. The message-body part is the session setting data 72 that has been set up by the SIP server 10, in which the positional information about a calling and receiving terminals (i.e., Contact information of INVITE and that of 200 OK) is set as the information retained by a Session Control (i.e., session control unit 111-2), and a forward and reverse directional transports are set as the information retained by a SIP Control (i.e., SIP control unit). The description method for the message-body shown by FIG. 10 is specified by the RFC2046 (Multipurpose Internet Mail Extensions).

Having received a 200 OK message 82, the caller terminal A (step 309) retains the session setting data 72, which is set in the message-body part, in either the memory area 22a or hard disk 23 comprised by its own terminal (step 310 shown by FIG. 8) and transmits an ACK message (step 311).

Having received the ACK message transmitted from the caller terminal A, the SIP server 10 sets a session setting data 72 in the message-body part of the ACK message (step 312) and transmits the aforementioned ACK message over to the receiver terminal B (step 313).

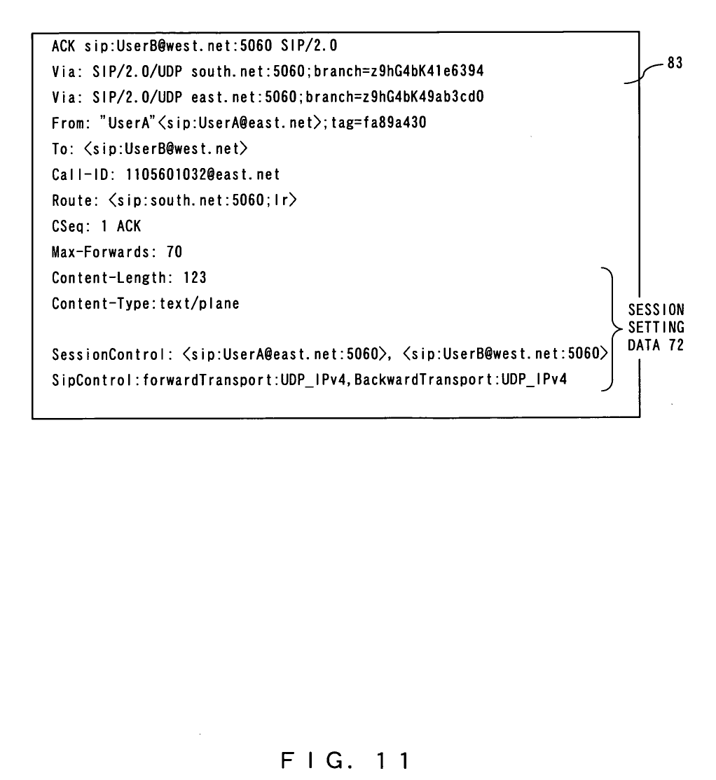

FIG. 11 shows an example of ACK message 83 which is set up with a session setting data 72. The message-body part of ACK message 83 is the same as the content described for the 200 OK message shown by FIG. 10.

Having received the ACK message 83, the receiver terminal B retains the session setting data 72 in the message-body part of the ACK message 83 in either the memory area 22a or hard disk 23 comprised by its own terminal (step 314).

The SIP server 10 releases an area of the memory area 22a which has been held for storing a session setting data 72, because the necessity of retaining the session setting data 72 within the SIP server 10 is gone now that the aforementioned session setting data 72 which has been retained by the memory area 22a is now retained by the caller and receiver terminals A and B (step 315).

Subsequently, the two terminals A and B start direct information communication (refer to the media stream 62 shown by FIG. 1) by using the aforementioned SIP session (step 316).

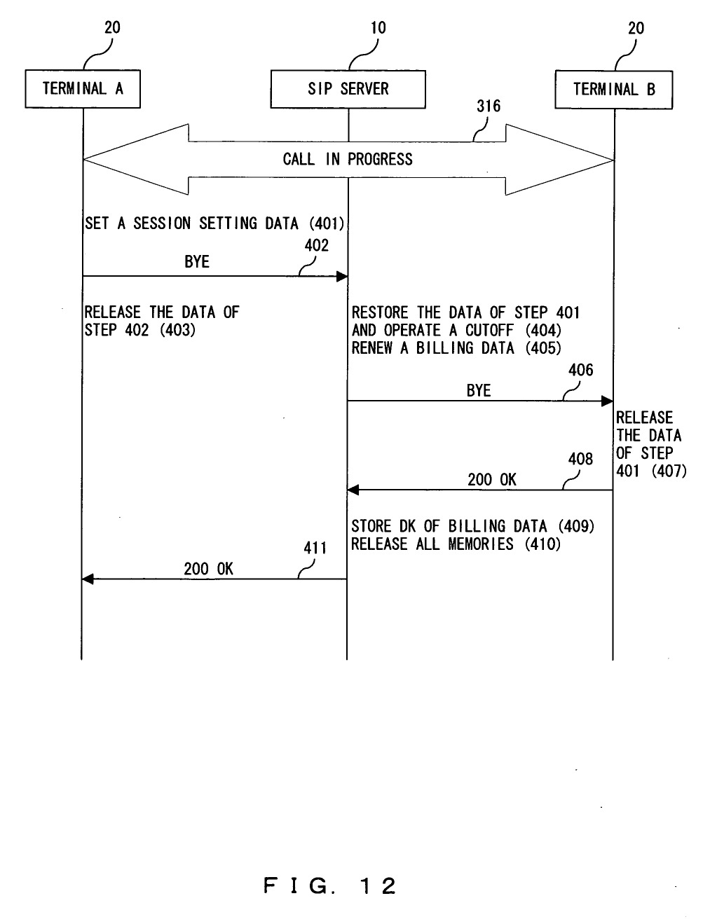

FIG. 12 shows a message sequence for an SIP session from a call in progress (i.e., step 316 shown by the above described FIG. 8) to the disconnection.

The caller terminal A transmits a BYE message in order to cut off the session, at which time it sets the session setting data 72 retained by either the memory area 22a or hard disk 23 comprised by its own terminal (step 401).

Having sent out the BYE message, the caller terminal A (step 402) releases the storage area of the memory area 12a or hard disk 23 retaining the session setting data 72 (step 403).

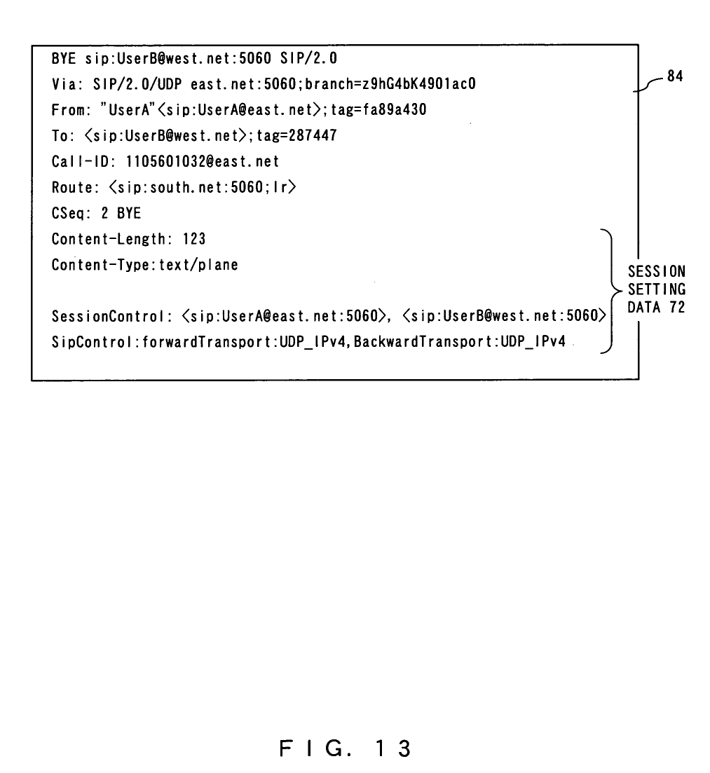

FIG. 13 shows an example of BYE message 84 which is set up with session setting data 72. A close look at the BYE message 84 finds that Content-type is set in the message-body of the text, which is the same content as the 200 OK message 82 shown by FIG. 10.

Having received a BYE message 84, the SIP server 10 extracts a session setting data 72 out of the message-body part thereof and develop the positional information about a caller and receiver terminals, which is the necessary information for a Session Control (i.e., session control unit 111-2), and the transport information about forward and reverse directions, which is the necessary information for an SIPControl (i.e., SIP control unit 111-3), in the memory area 22a as a part of the session management information 70, thereby restoring a memory state (i.e., corresponding session management information 70) during the call (step 404) to transmit a BYE message 84 for cutting off the session to the receiver terminal B by referring to the restored session management information 70 (step 406).

Meanwhile, the SIP server 10 collects the information for a billing data such as the reason for cutoff in the above event (step 405).

Having received the BYE message 84, the receiver terminal B releases the session setting data 72 stored by either the memory area 12a or hard disk 23 (step 407) and responds back with a 200 OK message 82 (step 408).

Having received the 200 OK message 82, the SIP server 10 collects information for a billing data 71 such as a call end time and stores the current session setting data 72 in a billing data file 18 comprised by an external storage apparatus 13 (step 409), followed by releasing all the memories (step 410) and transmitting a 200 OK message 82 over to the caller terminal A (step 411).

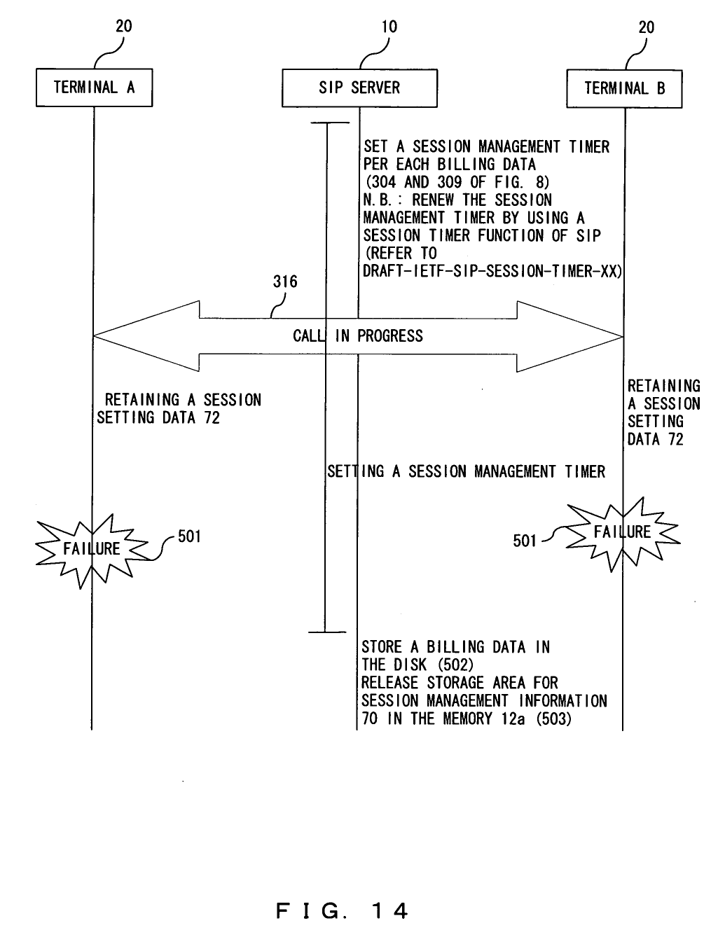

FIG. 14 is a sequence chart exemplifying a processing at an occurrence of terminal failure during a call. The present embodiment is comprised to set up a session management timer per each billing data 71 per each SIP session. The session management timer is renewed by using the session timer function of SIP (refer to draft-ietf-sip-session-timer-xx) for instance.

In a state of call in progress, if a fault occurs in the caller and/or receiver terminals A/B (step 501) and therefore the terminal A/B are unable to transmit a BYE message. However, because the SIP server 10 sets up a session management timer (i.e., setup is done in the steps 304 and 309 shown by FIG. 8) per each billing data 71 per each SIP session retained by the memory area 22a, thereby making it possible to store the billing data 71 in an external storage apparatus 13 at a time-up of the session management timer (step 502), and release the storage area for the session management information 70 set up in the memory area 12a in order to manage all the current SIP sessions (step 503). That is, the session management timer 91 is set at Session-Expires header of the INVITE message 81 and 200 OK (for INVITE) message 82 (refer to FIGS. 9 and 10) to use the values.

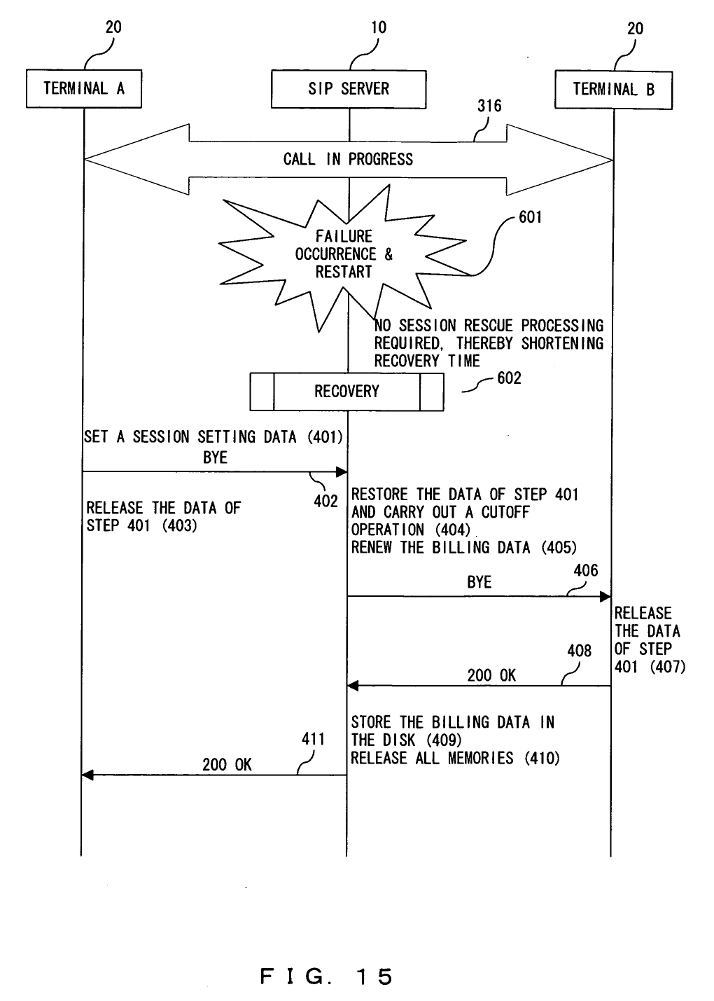

FIG. 15 is a sequence chart exemplifying a processing at an occurrence of failure in the SIP server 10 during a call.

In a state of call in progress, even if a failure occurs in the SIP server 10 (step 601) to require a restart, followed by the SIP server recovering (step 602) and by the caller terminal (i.e., the terminal A in this case) cutting off the connection (i.e., receives a BYE therefrom (step 402)), it is still possible to carry out a cutoff processing just as shown by the sequence chart in the above described FIG. 12. In FIG. 15, the same processing as the above described FIG. 12 is assigned by the same step numbers and the descriptions thereof are omitted here.

Meanwhile, if the SIP server 10 is restarted in the above described steps 601 and 602, there is no need to perform a recovery processing such as rebuilding each session by transmitting, from the SIP server 10 to each terminal engaging in each session, a session setting data 72 relating to each session of call in progress prior to the failure occurrence, thereby enabling a shortening of time between the failure occurrence and restart of the SIP server 10.

As described above, retaining an important billing data by the SIP server 10 and having the terminals relating to the current session (i.e., client 20) retain, by transmitting thereto, other session setting data 72 out of session management information 70 for setting up a session used by the SIP server 10 enable the SIP server 10 and clients 20 to carry out a distributed management of the session management information 70.

Also in the SIP server 10, releasing the storage area for a session setting data 72 in the memory area 12a after establishing a session (i.e., at the time of receiving an ACK message from the terminal) makes it possible to save a large space of the memory area 12a that as much as for storing the session setting data 72 when managing a plurality of sessions, as compared to retaining the session setting data 72 in the memory area 12a of the SIP server 10.

That is, because the storage area of the memory area 12a in order to store the session management information 70 within the SIP server 10 is released after establishing a session (at receiving an ACK), it is possible to alleviate a limitation in the maximum number of simultaneously connectable SIP sessions and hence accomplish a simultaneous management of a larger number of SIP sessions by the same storage capacity of the memory area 12a.

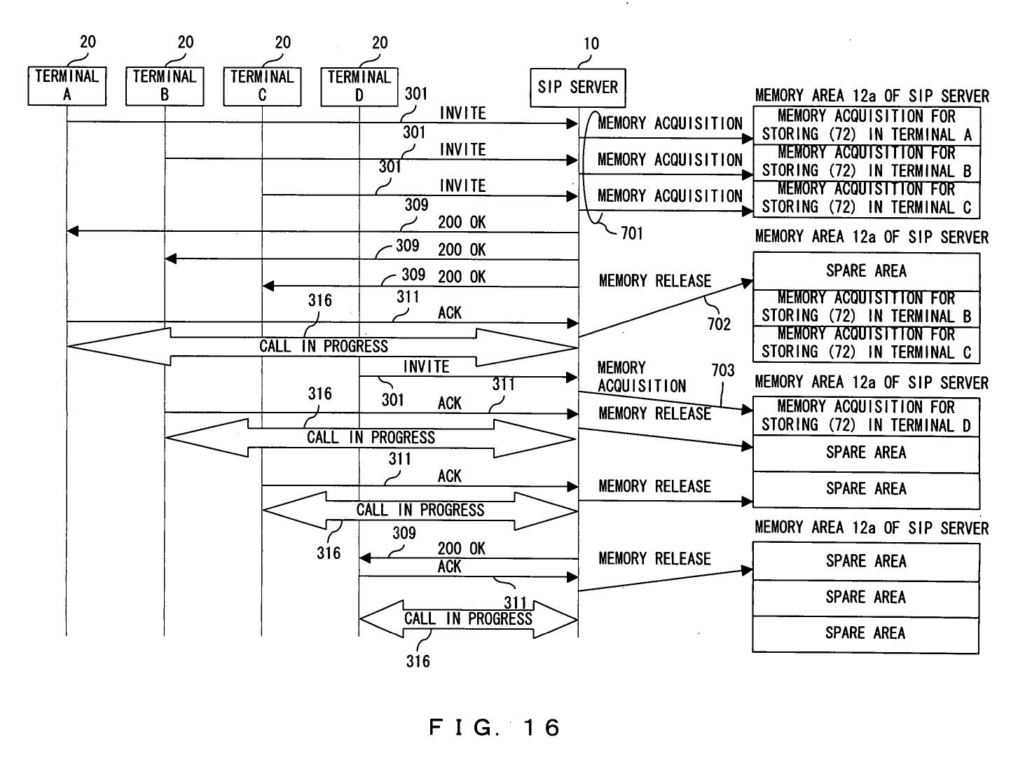

FIG. 16 shows a message sequence when connecting a plurality of sessions simultaneously. Note that the same processing as the above described FIG. 8 is assigned by the corresponding step numbers and the duplicate descriptions are omitted here.

Note that FIG. 16 exemplifies a message sequence associated with releasing a storage area of the memory area 12a in the SIP server 10, and therefore omits a receiver terminal. Also omitted here in the drawing are temporary response sequences in an SIP session such as 100 Tyring, 180 Ringing, et cetera, which have no direct relationship with the present embodiment.

If there is a possibility of receiving an INVITE message 81 from each of terminal B and terminal C (step 301) between the time the SIP server 10 receives an INVITE message 81 from a caller terminal A (step 301) and an ACK message therefrom (step 311), the storage area of the memory area 12a for storing a session setting data 72 within the SIP server 10 secures only a storage capacity for accommodating terminals A, B and C (step 701). At the time of receiving an ACK message from the terminal A, the SIP server 10 (step 311) releases the storage area for the session setting data 72 retaining in the memory area 12a for the terminal A (step 702). Subsequently, if the SIP server 10 receives an INVITE message 81 from a terminal D (step 301), it is possible to establish a session therewith by acquiring and allocating a storage area for a session setting data 72 in the memory area 12a which has been released before (step 703).

Above described configuration only requires securing a storage capacity expressed by: the number of sessions possibly occurring within the processing time for setting one session (i.e., the time from receiving an INVITE message to receiving an ACK message) multiplied by the capacity of session setting data 72, hence alleviating a limitation in the number of simultaneous connections due to the storage capacity of the memory area 12a and making it possible to manage a larger number of SIP sessions by using a memory area 12a of the same storage capacity.

In particular, when providing a communication service such as IP phone through the SIP session, the information volume of session setting data 72 contained by session management information 70 is on a ballooning trend in accomplishing additional services such as an automatic call transfer function and a guidance response. In such a case the present embodiment is configured to have each client 20 retain a session setting data 72 and therefore the number of simultaneous sessions manageable by the SIP server 10 will never decrease even if an information volume of the session setting data 72 is magnified.

In other words, various additional functions for a communication service by using the SIP sessions can be accomplished without reducing the number of simultaneous sessions manageable by the SIP server 10.

As a result, a reduction in a capacity of the memory area 12a required to comprise in a softswitch (i.e., SIP server 10) lightens a development limitation due to a bottle neck in the memory area 12a, improves an efficiency of developing a new service and reduces a development cost for the new service in an IP network by using the IP.

It is also possible to suppress a production cost and sales price of the SIP server 10 comprising a softswitch since it is possible to reduce the storage capacity of a memory area 12a because the same level of service can be accomplished by a smaller storage capacity thereof.

Meanwhile, if the softswitch fails, a service stoppage time of terminals is shortened since the recovery takes a shorter time.

And, an extended number of simultaneously connected sessions manageable by one softswitch (i.e., SIP server 10) reduces the number thereof furnished for an IP network and accomplishes a reduction of equipment cost in the IP networks by using the SIP.

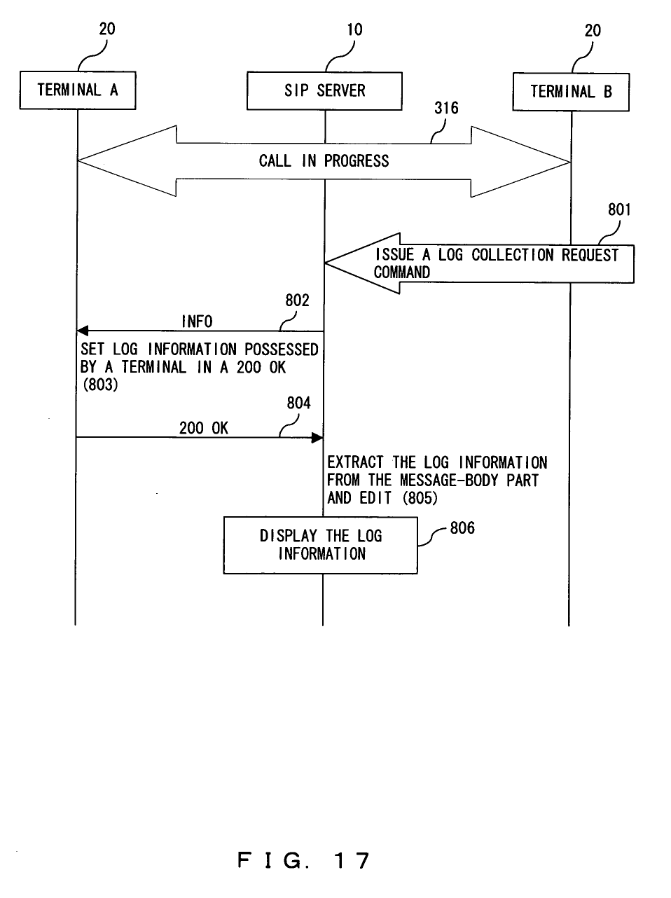

The next description is about a modification of the present embodiment while referring to FIGS. 17, 18 and 19. The modified embodiment shown by FIGS. 17 through 19 is configured so as to have clients 20 (i.e., terminal), which are engaged in each SIP session, to store log information in the hard disk 23 as a log management data 211-5 about an SIP signal (i.e., session control-use signal) such as the above described series of messages, et cetera, exchanging between the aforementioned client 20 and an SIP server 10 during an SIP session (refer to FIG. 6); and recover the log management data 211-5 from the client 20 to the SIP server 10 on an as required basis.

That is, the SIP server 10 makes requests for collecting the log management data 211-5 retained by the hard disk 23 comprised by each caller and receiver terminals (i.e., client 20).

The log management data 211-5 would demand a vast size of storage resource if the SIP server 10 tried to record it collectively, but if it is recorded by each client 20 engaging in each session distributedly as the present embodiment is so configured, then the recording becomes by the unit of session. Accordingly, the information volume of the log management data 211-5 in each client 20 is relatively small, hence easy on the storage resource thereof and allowing a record of the log management data 211-5 during a session for a relatively long period of time.

FIG. 17 exemplifies a sequence of the SIP server 10 requesting each caller and receiver terminals for collecting a log management data 211-5.

For instance, if a maintenance personnel issues a log collection request command to the SIP server 10 (step 801), then the SIP server 10 transmits an INFO message 85 to a caller terminal A (step 802).

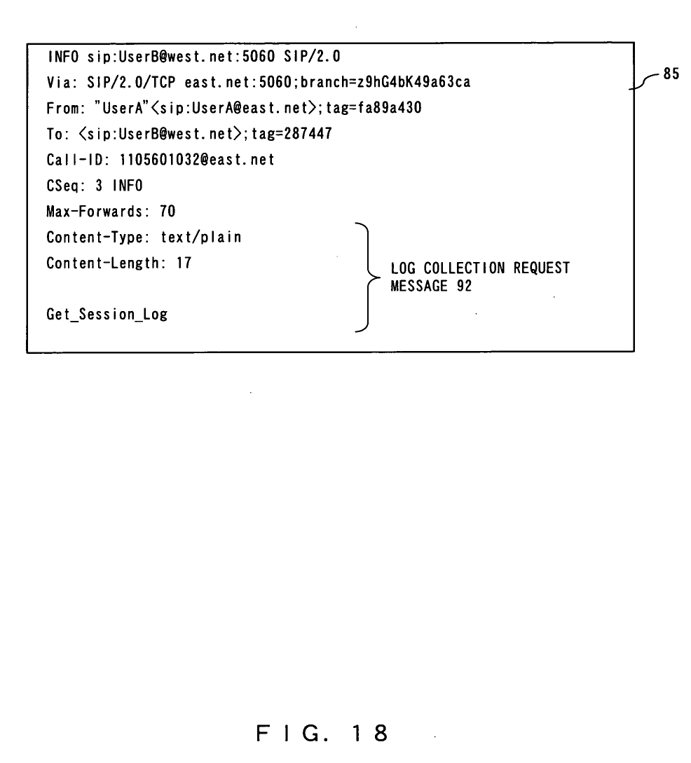

FIG. 18 shows an INFO message 85 set up with a log collection request message 92. Describing the INFO message 85 in detail, a log collection request message 92 is set in the message-body part of the INFO message 85. The content of the log collection request message 92 is discretionary if it is a prescribed message so as to be comprehensible between the terminals and SIP server 10.

Having received an INFO message 85, the caller terminal A refers to the message-body part and sets the specified log management data 211-5 in the message-body part of the 200 OK message 86 corresponding to the INFO message 85 (step 803).

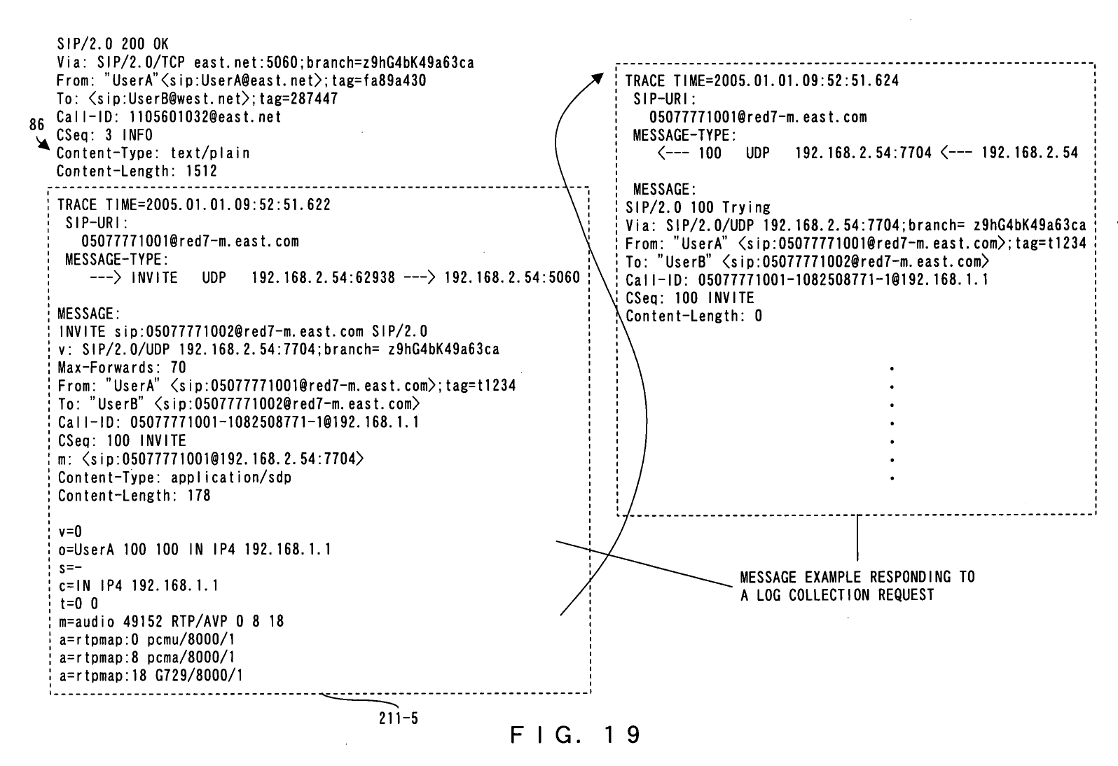

FIG. 19 shows an example of 200 OK message 86 set up with a log management data 211-5. Looking at the 200 OK message 86 in detail, one finds that the log management data 211-5 is set in the message-body part thereof.

Having received the 200 OK message 86 from the caller terminal A, the SIP server 10 (step 804) refers to the log management data 211-5 existing in the message-body and edit it if appropriate (step 805) to output the edited session control-use signal log information (i.e., log management data 211-5) (step 806).

As described above, the present modified embodiment is configured to let each client 20, which engages itself in a current session, record the log management data 211-5 which has recorded, in a time series, session control-use signals that have occurred between a generation of the current session and cutoff thereof, and then collects the log management data 211-5 in the SIP server 10 over from the client 20 on as required basis, thereby eliminating a need to equip a large storage resource in the SIP server 10 in order to retain the log management data 211-5.

In other words, it becomes possible to record the log management data 211-5 relating to all the sessions securely and utilize them effectively for an operation management of the network, et cetera, without being limited by a finiteness of storage resource within the SIP server 10.

For instance, maintenance personnel of the softswitch (i.e., SIP server 10) are enabled to collect log information about SIP signals from the client 20 in the whole state instead of being overwritten. It is also possible to collect log information by tracing back to the past for a random client 20 since there is no need to collect or register log information by specifying a specific client 20 due to a limitation of storage resource.

Note that it goes without saying that the present invention is in no way limited by the above described example embodiment and is possible to change in various ways within the scope of the present invention.

The present invention makes it possible to increase the number of simultaneously manageable sessions without causing a degradation in a session management performance due to a shortage of memory capacity in a softswitch with a finite memory capacity which stores session management information necessary for managing each session.

It also enables the addition of various new services without causing a degradation in a session management performance due to a shortage of memory capacity in a softswitch with a finite memory capacity which stores session management information necessary for managing each session.

It further enables a collection of log information about each session without causing a degradation in a session management performance due to a shortage of memory capacity in a softswitch with a finite memory capacity which stores session management information necessary for managing each session.

It yet further enables a collection of log information relating to each session freely in a softswitch with a finite memory capacity which stores session management information necessary for managing each session.
(remark 1). A signal for carrying a control program of a server apparatus intervening in a generation, maintenance and disconnection of session which is set up for communication between a plurality of client apparatuses connecting with each other by way of an information network, wherein

the program makes the server apparatus carry out the processes of

the server apparatus retaining a first session management information relating to a billing, and letting the client apparatus retain second session management information other than the first session management information, out of session management information created within the server apparatus in order to manage a session at the generation of the aforementioned session; and

recovering the second session management information from the client apparatus to the server apparatus at a disconnection of the aforementioned session.
(remark 2). The signal for carrying a control program of a server apparatus according to remark 1, wherein the program further makes the server apparatus carry out the process of collecting, from each of said client apparatuses, log information about session control signals which have been recorded therein on as required basis.
(remark 3). The signal for carrying a control program of a server apparatus according to remark 1, wherein the server apparatus is an SIP server for managing said session by using an SIP (Session Initiation Protocol)
(remark 4). A signal for carrying a control program of a client apparatus for carrying out communication with another client apparatus by way of a session controlled for its generation, maintenance and disconnection by an intervention of server apparatus, wherein

the program makes the client apparatus carry out the processes of

configuring session management information created within the server apparatus at a generation of the session in order to manage the aforementioned session, and retaining second management information, received from the server apparatus, out of first session management information relating to a billing and the second session management information other than the first session management information; and

transmitting the second session management information to the server apparatus at a disconnection of the session.
(remark 5). The signal for carrying a control program of a client apparatus according to remark 4, wherein the program further makes the client apparatus carry out the processes of

recording log information about session control signals, and

transmitting said log information to said server apparatus in compliance therewith.
(remark 6). A session control method of information communication system including

a plurality of first information processing apparatuses which are connected byway of an information network, and

a second information processing apparatus, being connected with the information network, for intervening in a generation, maintenance and disconnection of a session which is set up for communication between a plurality of the first information processing apparatus, comprising the processes of

the second information processing apparatus retaining a first session management information relating to a billing, and letting the first information processing apparatus retain second session management information other than the first session management information, out of session management information created within the second information processing apparatus in order to manage a session at the generation of the aforementioned session; and

recovering the second session management information from the first information processing apparatus to the second information processing apparatus at a disconnection of the aforementioned session.
(remark 7). The session control method according to remark 6, further comprising the processes of each of said first information processing apparatus recording log information about session control signals, and

said second information processing apparatus collecting the log information from the information processing apparatus on an as required basis.
(remark 8). The session control method according to remark 6, wherein said second information processing apparatus is an SIP server for managing said session by using an SIP (Session Initiation Protocol).

What is claimed is:

1. A control method of a server apparatus intervening in a generation, maintenance and disconnection of session which is set up for communication between a plurality of client apparatuses connecting with each other by way of an information network, comprising the processes of
retaining, by the server apparatus, first session management information relating to a billing out of session management information which is created within the server apparatus at a generation of the session, and transmitting second management information other than the first management information to the client apparatus; and
recovering the second session management information from the client apparatus to the server apparatus at a disconnection of the aforementioned session.

2. The control method of a server apparatus according to claim 1, further comprising the process of collecting, from each of said client apparatuses, log information about session control signals which have been recorded therein.

3. The control method of a server apparatus according to claim 1, wherein said server apparatus is an SIP server for managing said session by using an SIP (Session Initiation Protocol).

4. A control method of a client apparatus carrying out communication with another client apparatus by way of a session controlled for its generation, maintenance and disconnection by an intervention of server apparatus, comprising the processes of
configuring session management information created within the server apparatus at a generation of the session, and retaining second management information, received from the server apparatus, out of first session management information relating to a billing and the second session management information other than the first session management information; and
transmitting the second session management information to the server apparatus at a disconnection of the session.

5. The control method of a client apparatus according to claim 4, further comprising the processes of
recording log information about session control signals, and
transmitting said log information to said server apparatus in compliance therewith.

6. A server apparatus for intervening in a generation, maintenance and disconnection of session which is set up for communication between a plurality of client apparatuses connecting with each other by way of an information network, comprising the operating control logics for
retaining a first session management information relating to a billing, and transmitting second session management information other than the first session management information to the client apparatus, out of session management information created within the server apparatus in order to manage a session at the generation of the aforementioned session; and
recovering the second session management information from the client apparatus at a disconnection of the aforementioned session.

7. The server apparatus according to claim 6, wherein said control logic further carries out an operation of collecting, from each of said client apparatuses, log information about session control signals which have been recorded therein on an as required basis.

8. The server apparatus according to claim 6, being an SIP server for managing said session by using an SIP (Session Initiation Protocol).

9. A client apparatus for carrying out communication with another client apparatus by way of a session controlled for its generation, maintenance and disconnection by an intervention of a server apparatus, comprising control logics for the operations of
configuring session management information created within the server apparatus at a generation of the session in order to manage the aforementioned session, and retaining second management information, received from the server apparatus, out of first session management information relating to a billing and the second session management information other than the first session management information; and
transmitting the second session management information to the server apparatus at a disconnection of the session.

10. The client apparatus according to claim 9, wherein said control logic further carries out the operations of recording log information about session control signals, and transmitting said log information to said server apparatus in compliance therewith.
